(19) United States
(12) Patent Application Publication
(10) Pub. No.: US 2014/0132879 A1
(43) Pub. Date: May 15, 2014

(54) LIQUID CRYTSAL MODULE AND LIQUID CRYTSAL DISPLAY WITH THE SAME

(71) Applicant: SHENZHEN CHINA STAR OPTOELECTRONICS TECHNOLOGY CO., LTD., Shenzhen, Guangdong (CN)

(72) Inventors: Quan Li, Shenzhen City (CN); Yi-Cheng Kuo, Shenzhen City (CN); Yuchun Hsiao, Shenzhen City (CN)

(73) Assignee: Shenzhen China Star Optoelectronics Technology Co., Ltd., Shenzhen, Guangdong (CN)

(21) Appl. No.: 13/806,980

(22) PCT Filed: Nov. 28, 2012
(86) PCT No.: PCT/CN2012/085395

§ 371 Date: Dec. 26, 2012

(30) Foreign Application Priority Data
Nov. 14, 2012 (CN) 201210455810.7

(51) Int. Cl. G02F 1/1333

(52) U.S. Cl. CPC G02F 1/133308
USPC 349/58

(57) ABSTRACT

A liquid crystal module includes a liquid crystal glass, plastic frames, a front frame, and a COF base film is disclosed. Connecting pins of the COF base film closely connects to a first end of the liquid crystal glass. The plastic frames cover a rim of the liquid crystal glass. The front frame abuts against the plastic frames arranged on two opposite surfaces of the liquid crystal glass to fasten the liquid crystal glass. Wherein the liquid crystal module further includes a positioning member causes the COF base film to bend toward a predetermined direction. At least one end of the positioning member is fixed between the front frame and the plastic frame by the front frame. A liquid crystal device includes the above-mentioned liquid crystal module is also disclosed. The liquid crystal module prevents the COF base film from being stripped off or harmed so as to enhance the non-defective rate and reduce the manufacturing cost.

### BACKGROUND OF THE INVENTION

This application claims priority to China Patent Application No. 201210455810.7 filed on Nov. 14, 2012 entitled, LIQUID CRYSTAL MODULE AND LIQUID CRYSTAL DISPLAY WITH THE SAME, all of the disclosures of which are incorporated herein by reference in their entirety.

1. Field of the Invention

Embodiments of the present disclosure relate to display technology, and more particularly to a liquid crystal module and the liquid crystal display with the same.

2. Discussion of the Related Art

Liquid crystal devices include display modules for displaying images, and the backlight module is for providing the light source. Currently, Cold Cathode Fluorescent Lamp (CCFL) and Light Emitting Diode (LED) are common light sources. It can be understood that the LEDs will be adopted in future design due to the energy-efficient attribute.

For the LED liquid crystal modules, narrow border design is a future trend. The border of typical liquid crystal modules is less than 5 mm. However, in the assembly process of large-sized, high-resolution, and narrow border liquid crystal module, the front frame often causes the COF base film to be stripped off or harmed by the front frame.

FIG. 2 is a schematic view showing a curly COF base film resulting from the assembly of the front frame. As the width of the front frame 91 is larger than that of the COF base film 92, before the front frame 91 is assembled, the bending direction of the COF base film 92 is uncontrollable. As such, it is possible that the COF base film 4 may be stripped off, which affects the non-defective rate of the liquid crystal module.

### SUMMARY

The object of the claimed invention is to provide a liquid crystal module and the liquid crystal display with the same. The liquid crystal module prevents the COF base film from being stripped off or harmed so as to enhance the non-defective rate and to reduce the manufacturing cost.

In one aspect, a liquid crystal module includes: a liquid crystal glass, plastic frames, a front frame, and a COF base film, connecting pins of the COF base film closely connects to a first end of the liquid crystal glass, the plastic frames cover a rim of the liquid crystal glass, the front frame abuts against the plastic frames arranged on two opposite surfaces of the liquid crystal glass to fasten the liquid crystal glass; and wherein the liquid crystal module further comprises a positioning member causing the COF base film to bend toward a predetermined direction, and at least one end of the positioning member is fixed between the front frame and the plastic frame by the front frame; after the COF base film is bent, a second end of the COF base film is at a distance from the positioning member or from the plastic frames.

Wherein the positioning member is an L-shaped sheet made by plastic or metallic material, and a width of the positioning member is less than 0.3 mm.

In another aspect, a liquid crystal module includes: a liquid crystal glass, plastic frames, a front frame, and a COF base film, connecting pins of the COF base film closely connects to a first end of the liquid crystal glass, the plastic frames cover a rim of the liquid crystal glass, the front frame abuts against the plastic frames arranged on two opposite surfaces of the liquid crystal glass to fasten the liquid crystal glass; and wherein the liquid crystal module further comprises a positioning member causing the COF base film to bend toward a predetermined direction, and at least one end of the positioning member is fixed between the front frame and the plastic frame by the front frame.

Wherein an L-shaped holding cavity is defined in an internal side of the positioning member.

Wherein the positioning member causes a first end of the COF base film connecting to the first end of the liquid crystal glass to bend such that the COF base film is received in the holding cavity.

Wherein a shape of the front frame is the same with that of the positioning member, and an internal wall of the front frame abuts against the positioning member.

Wherein a width of the positioning member is less than or equal to the width of the COF base film.

Wherein a width of the positioning member is less than 0.3 mm.

Wherein the positioning member is an L-shaped sheet made by plastic or metallic material.

Wherein the positioning member comprises a horizontal sheet and a vertical sheet connected to the horizontal sheet, after the COF base film is bent, the first end and the second end of the COF base film are respectively parallel to the horizontal sheet and the vertical sheet of the positioning member.

Wherein after the COF base film is bent, at least the second end of the COF base film is at a distance from the positioning member or the plastic frames.

In another aspect, a liquid crystal display includes: a liquid crystal module comprising a liquid crystal glass, plastic frames, a front frame, and a COF base film, connecting pins of the COF base film closely connects to a first end of the liquid crystal glass, the plastic frames covers a rim of the liquid crystal glass, the front frame abuts against the plastic frames arranged on two opposite surfaces of the liquid crystal glass to fasten the liquid crystal glass; and wherein the liquid crystal module further comprises a positioning member for bending the COF base film toward a predetermined direction, and at least one end of the positioning member is fixed between the front frame and the plastic frame by the front frame.

Wherein an L-shaped holding cavity is defined in an internal side of the positioning member.

Wherein the positioning member causes a first end of the COF base film connecting to the first end of the liquid crystal glass to bend such that the COF base film is received in the holding cavity.

Wherein a shape of the front frame is the same with that of the positioning member, and an internal wall of the front frame abuts against the positioning member.

Wherein a width of the positioning member is less than or equal to the width of the COF base film.

Wherein a width of the positioning member is less than 0.3 mm.

Wherein the positioning member is an L-shaped sheet made by plastic or metallic material.

Wherein the positioning member comprises a horizontal sheet and a vertical sheet connected to the horizontal sheet, after the COF base film is bent, the first end and the second end of the COF base film are respectively parallel to the horizontal sheet and the vertical sheet of the positioning member.

Wherein after the COF base film is bent, at least the second end of the COF base film is at a distance from the positioning member or the plastic frames.

In view of the above, the positioning member is arranged to cause the COF base film to bend toward a predetermined direction. One end of the positioning member is fixed between the front frame and the plastic frames by the front frame. The positioning member may be applied to the narrow border design to prevent the COF base film from being stripped off or harmed.

### BRIEF DESCRIPTION OF THE DRAWINGS

FIG. 1 is a schematic view of a liquid crystal module assembled with a positioning member in accordance with one embodiment.

FIG. 2 is a schematic view showing a curly COF base film caused by the front frame assembly of a typical liquid crystal module.

### DETAILED DESCRIPTION OF THE EMBODIMENTS

Embodiments of the invention will now be described more fully hereinafter with reference to the accompanying drawings, in which embodiments of the invention are shown.

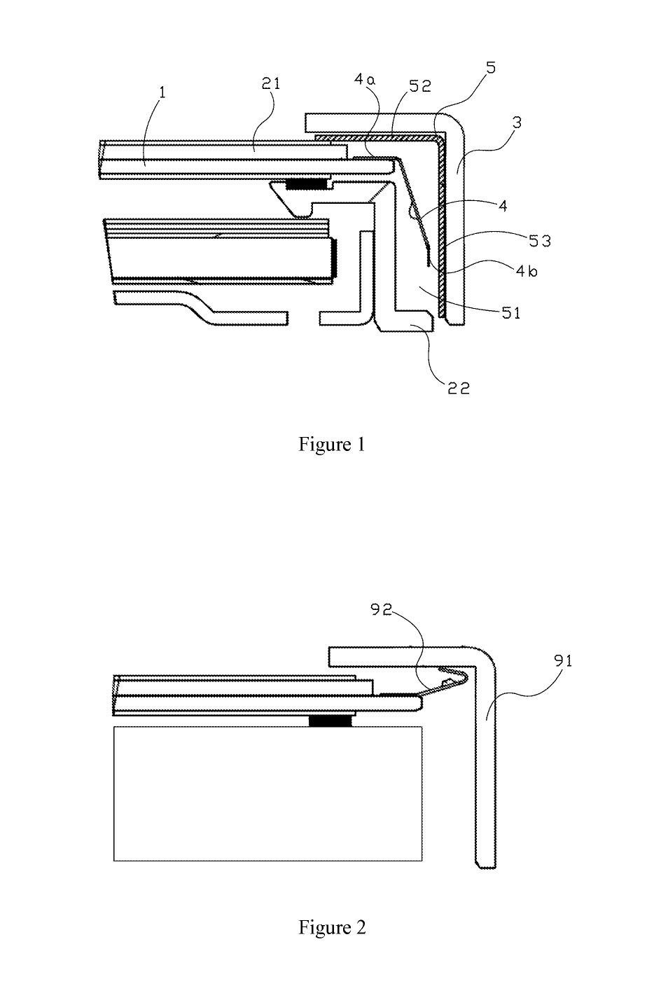

FIG. 1 is a schematic view of a liquid crystal module assembled with a positioning member in accordance with one embodiment. The liquid crystal module includes a liquid crystal glass 1, plastic frames, a front frame 3, and a COF base film 4.

An up surface and a down surface of the liquid crystal glass 1 are respectively pressed by the plastic frames. As shown in FIG. 1, the plastic frames include a top plastic frame 21 arranged above the up surface of the liquid crystal glass 1 and a down plastic frame 22 arranged below the down surface of the liquid crystal glass 1. After the top plastic frame 21 and the down plastic frame 22 are positioned, the front frame 3 presses the top plastic frame 21 and the down plastic frame 22. In this way, the liquid crystal glass 1 is fixed by the top plastic frame 21 and the down plastic frame 22.

A first end 4a of the COF base film 4 closely connects to a first end of the liquid crystal glass 1. In the assembly process, the COF base film 4 is in an unbent state. That is, in the assembly process, the first end 4a and a second end 4b of the COF base film 4 are in a plane.

In one embodiment, a positioning member 5 is arranged to cause the COF base film 4 to bend downward. In this way, the COF base film 4 may be received in a holding cavity 51. It can be understood that the COF base film 4 has to be bent to meet the requirements of narrow border design.

The positioning member 5 prevents the COF base film 4 from being stripped off when assembling the front frame 3. The detail structures and assembly process will now be described more fully hereinafter

The positioning member 5 is an L-shaped sheet made by plastic or metallic material. Usually, the positioning member 5 and the front frame 3 are made by the same material such that the weight of the liquid crystal module is controlled to be within a range. The positioning member 5 includes a horizontal sheet 52 and a vertical sheet 53 that is vertical to the horizontal sheet 52. One end of the horizontal sheet 52 is fixed with the top plastic frame 21. The vertical sheet 53 connected with the horizontal sheet 52 is located at a distance from the down plastic frame 22.

The horizontal sheet 52, the vertical sheet 53, the top plastic frame 21, and the Z-shaped down plastic frame 22 cooperatively define the L-shaped holding cavity 51. The first end of the liquid crystal glass 1 pressed by the plastic frames 21, 22 and the first end 4a of the COF base film 4 are received in the holding cavity 51.

Furthermore, the positioning member 5 is for causing the COF base film 4 to bend toward a predetermined direction.

Specifically, the positioning member 5 is for causing the second end 4b of the COF base film 4 to bend toward an internal of the holding cavity 51. When the COF base film 4 is received in the holding cavity 51, the second end 4b is at a distance from the vertical sheet 53 of the positioning member 5 and the down plastic frame 22. In this way, as the second end 4b is bent toward the predetermined direction, the COF base film 4 does not contact with the positioning member 5 and the front frame 3.

The shape of the front frame 3 is the same with that of the positioning member 5. An internal wall of the front frame 3 abuts against the positioning member 5.

In the assembly process, after the COF base film 4 is bent, one end of the horizontal sheet 52 of the positioning member 5 is fixed on the top plastic frame 21 above the liquid crystal glass 1. In this way, the locations of the horizontal sheet 52, the vertical sheet 53, the top plastic frame 21, and the down plastic frame 22 are fixed. Afterward, the positioning member 5 is fixed by the internal wall of the front frame 3.

Preferably, a width of the positioning member 5 is less than or equal to the width of the COF base film 4. As such, it is easier to obverse the bending direction of the COF base film 4. In order to facilitate the front frame assembly, the dimension of the positioning member 5 has to be as small as possible. In addition, the material cost is also reduced.

For example, when the width of the positioning member 5 is substantially the same with that of the COF base film 4, the bending direction of the COF base film 4 may be observed. At the same time, it can be seen that the first end 4a and the second end 4b of the COF base film 4 are respectively parallel to the horizontal sheet 52 and the vertical sheet 53 of the positioning member 5.

Preferably, the width of the positioning member 5 is less than 0.3 mm to decrease the impact bring from the front frame assembly. According to experimental results, when the width of the positioning member 5 is less than 0.3 mm, the front frame 3 is capable of pressing the plastic frames so as to strengthen the structure. In addition, by arranging a thinner positioning member 5, the material cost is reduced.

In one embodiment, a liquid crystal display includes the above-mentioned liquid crystal module.

In view of the above, the positioning member is arranged to cause the COF base film to bend toward the predetermined direction. One end of the positioning member is fixed between the front frame and the plastic frames by the front frame. The positioning member may be applied to the narrow border design to prevent the COF base film from being stripped off or harmed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal module, comprising:
a liquid crystal glass, plastic frames, a front frame, and a COF base film, connecting pins of the COF base film closely connects to a first end of the liquid crystal glass, the plastic frames cover a rim of the liquid crystal glass, the front frame abuts against the plastic frames arranged on two opposite surfaces of the liquid crystal glass to fasten the liquid crystal glass; and
wherein the liquid crystal module further comprises a positioning member causing the COF base film to bend toward a predetermined direction, and at least one end of the positioning member is fixed between the front frame and the plastic frame by the front frame;
after the COF base film is bent, a second end of the COF base film is at a distance from the positioning member or from the plastic frames.

2. The liquid crystal module as claimed in claim 1, wherein the positioning member is an L-shaped sheet made by plastic or metallic material, and a width of the positioning member is less than 0.3 mm.

3. A liquid crystal module, comprising:
a liquid crystal glass, plastic frames, a front frame, and a COF base film, connecting pins of the COF base film closely connects to a first end of the liquid crystal glass, the plastic frames cover a rim of the liquid crystal glass, the front frame abuts against the plastic frames arranged on two opposite surfaces of the liquid crystal glass to fasten the liquid crystal glass; and
wherein the liquid crystal module further comprises a positioning member causing the COF base film to bend toward a predetermined direction, and at least one end of the positioning member is fixed between the front frame and the plastic frame by the front frame.

4. The liquid crystal module as claimed in claim 3, wherein an L-shaped holding cavity is defined in an internal side of the positioning member.

5. The liquid crystal module as claimed in claim 4, wherein the positioning member causes a first end of the COF base film connecting to the first end of the liquid crystal glass to bend such that the COF base film is received in the holding cavity.

6. The liquid crystal module as claimed in claim 5, wherein a shape of the front frame is the same with that of the positioning member, and an internal wall of the front frame abuts against the positioning member.

7. The liquid crystal module as claimed in claim 6, wherein a width of the positioning member is less than or equal to the width of the COF base film.

8. The liquid crystal module as claimed in claim 6, wherein a width of the positioning member is less than 0.3 mm.

9. The liquid crystal module as claimed in claim 6, wherein the positioning member is an L-shaped sheet made by plastic or metallic material.

10. The liquid crystal module as claimed in claim 9, wherein the positioning member comprises a horizontal sheet and a vertical sheet connected to the horizontal sheet, after the COF base film is bent, the first end and the second end of the COF base film are respectively parallel to the horizontal sheet and the vertical sheet of the positioning member.

11. The liquid crystal module as claimed in claim 5, wherein after the COF base film is bent, at least the second end of the COF base film is at a distance from the positioning member or the plastic frames.

12. A liquid crystal display, comprising:
a liquid crystal module comprising a liquid crystal glass, plastic frames, a front frame, and a COF base film, connecting pins of the COF base film closely connects to a first end of the liquid crystal glass, the plastic frames covers a rim of the liquid crystal glass, the front frame abuts against the plastic frames arranged on two opposite surfaces of the liquid crystal glass to fasten the liquid crystal glass; and
wherein the liquid crystal module further comprises a positioning member for bending the COF base film toward a predetermined direction, and at least one end of the positioning member is fixed between the front frame and the plastic frame by the front frame.

13. The liquid crystal display as claimed in claim 12, wherein an L-shaped holding cavity is defined in an internal side of the positioning member.

14. The liquid crystal display as claimed in claim 13, wherein the positioning member causes a first end of the COF base film connecting to the first end of the liquid crystal glass to bend such that the COF base film is received in the holding cavity.

15. The liquid crystal display as claimed in claim 14, wherein a shape of the front frame is the same with that of the positioning member, and an internal wall of the front frame abuts against the positioning member.

16. The liquid crystal display as claimed in claim 15, wherein a width of the positioning member is less than or equal to the width of the COF base film.

17. The liquid crystal display as claimed in claim 15, wherein a width of the positioning member is less than 0.3 mm.

18. The liquid crystal display as claimed in claim 15, wherein the positioning member is an L-shaped sheet made by plastic or metallic material.

19. The liquid crystal display as claimed in claim 18, wherein the positioning member comprises a horizontal sheet and a vertical sheet connected to the horizontal sheet, after the COF base film is bent, the first end and the second end of the COF base film are respectively parallel to the horizontal sheet and the vertical sheet of the positioning member.

20. The liquid crystal display as claimed in claim 15, wherein after the COF base film is bent, at least the second end of the COF base film is at a distance from the positioning member or the plastic frames.
